(19) United States
(12) Patent Application Publication
(10) Pub. No.: US 2025/0031714 A1
(43) Pub. Date: Jan. 30, 2025

(54) FOOD PRODUCT

(71) Applicant: Mars, Incorporated, McLean, VA (US)

(72) Inventors: Hans VAN HOUTUM, Veghel (NL); Robin LAARMAN, Veghel (NL); Stephan MEULENSTEEN, Veghel (NL); Lauren POPESCU, Hackettstown, NJ (US)

(21) Appl. No.: 18/716,042

(22) PCT Filed: Dec. 2, 2022
(86) PCT No.: PCT/US2022/051700

§ 371 Date: Jun. 3, 2024

Related U.S. Application Data
(60) Provisional application No. 63/285,528, filed on Dec. 3, 2021.

(51) Int. Cl. A23G 1/48; A23G 1/44; A23G 1/54; A23G 3/44; A23G 3/48; A23G 3/54

(52) U.S. Cl. CPC A23G 1/48; A23G 1/44; A23G 1/54; A23G 3/44; A23G 3/48; A23G 3/54

(57) ABSTRACT

The invention relates to a food product comprising a plant-based nougat component, wherein the plant-based nougat component comprises from 0.5-20 wt % plant-based protein and from 1-30 wt % plant-based powder; a plant-based caramel component; and a plant-based chocolate component.

### CROSS-REFERENCE TO RELATED APPLICATION(S)

This is a National Stage Application under 35 U.S.C. § 371 of International Application No. PCT/US2022/051700, filed on Dec. 2, 2022, which claims priority to U.S. Patent Application No. 63/285,528, filed on Dec. 3, 2021, the entireties of which are incorporated herein by reference.

### FIELD OF THE INVENTION

The present invention relates to a plant-based food product, which may be termed a confection. A method for making the food product is also provided.

### BACKGROUND OF THE INVENTION

Confectionery products such as chocolate are popular food products and plant-based food products are becoming increasingly desirable to consumers. This is due to consumer concerns relating to animal welfare, the environmental impact of animal farming, and health risks associated with animal products. Plant-based food products include vegan food products. The traditional ingredients for chocolate are derived from the cocoa bean. As such, chocolate can be prepared as a plant-based product.

However, many chocolate products contain ingredients derived from animals and are not plant-based. Products labelled “milk chocolate” usually contain animal-derived milk, with added sugars. Products labelled “dark chocolate” may also contain milk and sugar, but in lower quantities. Chocolate products may contain other ingredients derived from animals, e.g., whey, casein, and certain emulsifiers. Many chocolate products also contain additional elements, such as caramels, nougats or biscuit, all of which also contain sugars. It is typically difficult to reformulate an existing food product which contains ingredients derived from animals into a plant-based or vegan product while still providing a food product which is enjoyed by consumers.

Dairy products such as milk chocolate or confectionery products containing animal derived ingredients such as milk, egg and dairy protein can be problematic for those with allergies or food intolerances, or those who adhere to dairy-free or vegan diets. There is an increasing need to provide a vegan or dairy-free chocolate or confectionery product that has the same taste and pleasing mouthfeel as standard milk chocolate or confectionery products containing dairy ingredients or animal-based ingredients. There is, therefore, a continuing need in the confectionery field to match consumer expectations in terms of an organoleptically desirable vegan or plant-based confectionery.

Furthermore, confectionery products containing high levels of refined or added sugars can be problematic for those suffering from diabetes, or those who are obese or overweight and are attempting to lose weight. There is therefore an additional increasing need to provide not only a vegan or dairy-free chocolate or confectionery product but one that is also a low-sugar confection that possesses the taste, texture and feel of a standard milk chocolate confection, is economical to produce, and has favourable processability and rheological properties. “Vegan milk chocolates” are well known and have been prepared in the prior art, using coconut milk, rice milk, or almond milk.

In particular, there is a need, however, to provide multi-textured plant-based confectionery items such as composite chocolate bars which typically comprise components made up of nougat, caramel and/or nuts. These types of confections provide particular challenges as such products can be difficult to manufacture. There is a need for further plant-based, low-sugar food products.

Nougat is another popular confectionery item. Nougat is typically not a plant-based product. Nougat may be available as a discrete product in itself or present as a component of composite confectionery items such as bars which comprise other elements such as chocolate, as well as caramels including aerated caramels, toffees, fudges, nuts, wafers, biscuits, gels, flavoured creams or pralines. Nougats traditionally comprise sugars which may be in the form of honey or sugar syrups based on refined sugars, as well as egg white, which provides a source of protein. Some nougats are hard and chewy but softer nougats, sometimes called nougatines, contain higher moisture content. They may contain ingredients such as cocoa, milk powder, lactose, malt and icing sugar, which have a shortening effect. Fat and emulsifiers may also be included. Typical nougat recipes are described for example in ‘Sugar Confectionery Manufacture’ (Berlin: Springer) Second edition, 1995 Ed. E.B. Jackson and in particular in Table 13.3 which shows some specific examples.

As described in US2017/245519A1, nougat is typically prepared by mixing together appropriate amounts of a sugar syrup and a protein mixture, aerating the mixture and thereafter mixing the resultant frappe with a suitable quantity of flavouring/graining mixture. Typically, frappe is prepared using a syrup solution prepared by mixing a sugar such as granulated sucrose with sufficient water to form a solution, which sugar solution is formed into a ‘base syrup’ or ‘doctor syrup’ by addition of glucose and optionally other ingredients such as salt.

It is then generally necessary to subject the base syrup to a heating or cooking procedure to remove at least some of the water before the syrup is of an appropriate concentration to go forward to the subsequent processing stages. Highly elevated temperatures, for example, of up to 140° C. are generally required in order to evaporate water so as to reduce the water content in line with the recipe. On cooling, the resultant syrup forms a highly saturated solution which changes state during production to a crystalline form to obtain the desired texture properties. Residual energy may be used subsequently to assist in coagulating protein. Notably, the protein is typically derived from animals, such as powdered egg and/or milk protein. The egg and/or milk protein is typically considered to be necessary to create a stable aerated sugar network.

Caramel is another popular confectionery product. Caramels, toffees and fudges are particularly popular confectionery items. They may be available as a discrete product in itself. Alternatively, they may be present as a component of composite confectionery items such as bars which comprise other elements such as chocolate, as well as nougats, nuts, wafers, biscuits, gels, flavoured creams or praline. Caramels are characterised as high sugar containing confections. A substantial proportion of the sugar may be provided by glucose syrup or sucrose, but caramels typically also contain fats, milk, flavourings and water.

The amount of water present in any particular caramel, toffee or fudge, will impact on its taste and texture, but also, of its processability. And, while some caramel, toffee or fudge confections are desirably more fluid, e.g., ice cream toppings or certain filled confections, in other applications, these confections may desirably be chewy in texture. Such confectionery items will contain less water. While the former can be messy to consume, but easy to deposit, the latter provides a cleaner consuming experience, but can be difficult to handle during manufacture.

Nougat and caramel are typically not plant-based food products because they contain ingredients such as dairy protein and/or egg protein. For example, typical nougats comprise an aerated sugar network which is stabilised by dairy and/or egg protein. Typical caramels comprise dairy products such as milk. There is a need for plant-based low-calorie alternatives to nougat and caramel.

WO 2018/167788 A1 discloses non-dairy and/or vegan confectionery products, especially chocolate-based products, and methods of their preparation. WO 2011/072834 A1 discloses a chocolate composition comprising cocoa butter, sugar, and coconut milk. EP 3369324 A1 discloses a formulation of a mixture especially designed for producing milk-free (milk protein-free and lactose-free), sugar-free and soy-free white chocolate with or without fibres in its composition. EP 3338559 A1 discloses a chocolate formulation with carob, with low caffeine and theobromine contents, animal milk-free, with or without added sugars, gluten-free, soy-free, with or without fiber, using cocoa and carob as the basis, alternatively supplemented with coconut fat, rice derivatives, powdered sweet potato and sugars having a low glycaemic index.

TW 201032726 A discloses a nougat composition comprising: 32-41 wt % maltose, 17-22 wt % sugar, 6-8 wt % fat/oil, 6-10 wt % mixed cereal powder, 20-30 wt % nuts material, 3-6 wt % water, and 0.01-5 wt % protein material.

The following disclosure is presented to provide an illustration of the general principles of the present invention and is not meant to limit, in any way, the inventive concepts contained herein. Moreover, the features described in this section can be used in combination with the other described features in each of the multitude of possible permutations and combinations contained herein.

### SUMMARY OF THE INVENTION

The invention provides a food product comprising:
a plant-based nougat component, wherein the plant-based nougat component comprises from 0.5-20 wt % plant-based protein and from 1-30 wt % plant-based powder;
a plant-based caramel component;
a plant-based chocolate component.

In some examples, one or more of the plant-based nougat component, the plant-based caramel component and the plant-based chocolate component comprises soluble fiber. It has been found that a plant-based low-sugar food product according to the invention scores well in consumer taste tests and thus provides an acceptable alternative to existing food products containing ingredients derived from animals.

### DETAILED DESCRIPTION OF THE PREFERRED EMBODIMENTS

The present specification provides certain definitions and methods to better define the present invention and to guide a person skilled in the art in the practice of the present invention. Provision, or lack of the provision, of a definition for a particular term or phrase is not meant to imply any particular importance, or lack thereof. Rather, and unless otherwise noted, terms are to be understood according to conventional usage by those persons skilled in the relevant art. Additional features and advantages of the present invention are described in, and will be apparent from, the description of the presently preferred embodiments which follow below.

As used herein, the term “plant-based” refers to a product which is formulated without ingredients derived from animals. A plant-based product may contain traces of ingredients derived from animals, such as traces of dairy ingredients. For example, traces of dairy ingredients may be present in plant-based products due to use of manufacturing lines which have previously been used to make dairy-based products. The term “plant-based” may refer to a product which comprises less than 1 wt %, preferably less than 0.1 wt % ingredients derived from animals.

As used herein, the term “plant-based” encompasses the term “vegan”. The term “vegan” refers to a product which is formulated without ingredients derived from animals or insects. The term “vegan” may refer to a product which comprises less than 1 wt %, preferably less than 0.1 wt % ingredients derived from animals or insects. The plant-based products and processes of the invention are preferably vegan products and processes.

As used herein, the terms “low sugar”, “added sugar”, “simple sugar” and “refined sugar” refer to processed sugars, as would be obtained from the processing of sugar beet and sugar cane to obtain, for example, the pure monosaccharides glucose and fructose, or the disaccharide sucrose. Refined sugars such as pure sucrose, glucose and fructose are high glycaemic carbohydrates, and are thus undesirable in products for those seeking to manage their weight. The terms are not intended to encompass naturally occurring sugar products such as honey, nor any naturally occurring polysaccharide or oligosaccharide containing glucose or fructose, nor any lactose (a disaccharide) that may be naturally present in any milk or dairy product that may be used in the preparation of the food product.

As used herein, the terms “dietary fiber”, “soluble dietary fiber”, “soluble fiber” or “water soluble (dietary) fiber” are to naturally occurring materials such as inulin, a fructan based on polyfructose, and shorter oligofructosaccharides, that are water soluble, or at least swell in water. Other soluble dietary fibers that may be used in any component of the present food product include dextrins, which are low molecular weight polyglucose molecules produced by the hydrolysis of starch or glycogen. These materials have a low calorific content (approximately 1 cal/g), and so are desirable substitutes for refined sugars, in particular as bulk sugar replacers typically used in confectionery. Other sources of water soluble dietary fiber include beta glucan, carrageneen, guar, gum acacia, xanthan gum, and pectin, and combinations thereof. A further example of soluble dietary fibers includes soluble corn fiber (SCF), an example of such an SCF is PROMITOR® Soluble Fibre 70 (supplied by Tate & Lyle).

As used herein, a “low sugar” milk chocolate is a milk chocolate having less than 50 wt %, or less than 30 wt %, or less than 25 wt % of an added/refined sugar selected from sucrose, glucose and fructose, including syrups thereof.

As used herein, references to “weight percent” or “wt %” are to the amount of a particular component in a composition, based on the total weight of that composition. For example, references to “wt %” of a soluble fiber in a caramel component are to the amount (by weight) of the soluble fiber in the caramel component, and not to the total amount (by weight) of the soluble fiber in a food product including the caramel component, unless otherwise stated.

### Food Product

Herein is provided a food product comprising:
a plant-based nougat component, wherein the plant-based nougat component comprises from 0.5-20 wt % plant-based protein and from 1-30 wt % plant-based powder;
a plant-based caramel component;
a plant-based chocolate component.

Herein is provided a food product comprising
a plant-based nougat component as described herein;
a plant-based caramel component as described herein;
a plant-based chocolate component as described herein.

The food product may comprise, consist essentially of, or consist of:
the plant-based nougat component as described herein; and
the plant-based caramel component as described herein; and
the plant-based chocolate component as described herein.

The food product may have a weight typical for a confectionery product. For example, the weight may be 1 to 70 g, for example 5 to 70 g, 5 to 60 g, optionally 20 to 60 g, optionally 30 to 60 g, optionally 40 to 60 g, optionally 20 to 40 g, optionally 1 to 20 g, optionally 1 to 10 g. The weight may preferably be about 20 g. The food product may be a confectionery product. The product may have dimensions typical for a confectionery product. The food product may be in the form of a bite size product or a bar. The bar may have a length of 15-50 mm, preferably 20-45 mm, most preferably 25-40 mm; a width of 10-50 mm, preferably 15-45 mm, most preferably 20-40 mm; and a height of 5-35 mm, preferably 10-30 mm, most preferably 12-25 mm. The height of the plant-based nougat may be 4-25 mm, for example 4-20 mm, for example 6-15 mm, preferably 8-12 mm, preferably about 10 mm along the length (longest dimension) of the food product. The height of the plant-based caramel may be 1-10 mm, preferably about 3 mm along the length (longest dimension) of the food product.

The plant-based food product is preferably a composite confectionery product. Preferably, the plant-based food product is a composite confection comprising the following components: plant-based chocolate, plant-based nougat and plant-based caramel. The plant-based composite food product may further contain inclusions in any of the components. The plant-based chocolate preferably forms a coating encasing or enrobing the plant-based nougat and plant-based caramel.

The food product may comprise 1-60 wt %, preferably 10-50 wt %, preferably 15-55 wt %, preferably 25-45 wt %, preferably 25-40 wt %, most preferably 30-40 wt % plant-based chocolate, with 1-60 wt %, preferably 5-40 wt %, preferably 10-20 wt %, preferably 15-55 wt %, preferably 25-45 wt %, most preferably 30-40 wt % plant-based caramel, with at least 90 wt %, optionally 100 wt %, of the remaining food product being the plant-based nougat. The food product may comprise a layer comprising the plant-based nougat and a further layer comprising the plant-based chocolate. The plant-based chocolate may partly or completely cover the plant-based nougat. The plant-based nougat may form a layer and the plant-based chocolate may cover one or more sides of, optionally all sides of, the layer of plant-based nougat. The food product may comprise a layer comprising the plant-based nougat and a further layer comprising the plant-based caramel. The plant-based caramel may partly or completely cover the plant-based nougat. The plant-based nougat may form a layer and the plant-based caramel may cover one or more sides of, optionally all sides of, the layer of plant-based nougat. The food product may be in the form of a bar, which may be an elongate bar or a bar approximately square in shape.

The food product may comprise a first layer comprising the plant-based nougat, a second layer comprising the plant-based caramel and a third layer comprising the plant-based chocolate. The plant-based chocolate may partly or completely cover the plant-based nougat and the plant-based caramel. The food product may comprise a layer of plant-based nougat and a layer of plant-based caramel disposed on a side of the plant-based nougat, and the plant-based chocolate may cover one or more sides of, optionally all sides of, the layers of plant-based nougat and plant-based caramel. The food product may comprise a single layer of plant-based nougat and a single layer of plant-based caramel disposed on a side of the plant-based nougat, and the plant-based chocolate may cover one or more sides of, optionally all sides of, the layers of the plant-based nougat and plant-based caramel, to form a plant-based chocolate-covered bar. The food product may be in the form of a bar, which may be an elongate bar or a bar approximately square in shape.

Herein is provided a method of producing a food product, the method comprising combining a plant-based nougat component described herein, a plant-based caramel component described herein, and a plant-based chocolate component described herein to form the food product.

In an embodiment, the plant-based nougat is produced, preferably in the form of a layer, and then a layer of plant-based caramel is disposed on the plant-based nougat, to form an intermediate bar, and then the plant-based chocolate is coated onto one or more sides of, preferably all sides of, the intermediate bar, to completely envelope the plant-based caramel and plant-based nougat.

In some examples, the food product comprises less than 30 wt % sugar content, by which it will be understood that this refers to the total content of refined sugars and/or naturally occurring sugars such as honey, and not to any naturally occurring polysaccharides or oligosaccharides that may be present as soluble fiber.

It has unexpectedly been discovered that a plant-based food product of caramel and nougat enrobed in chocolate can be prepared without sacrificing any of the sensory experience with regard to at least flavours and textures.

### Plant-Based Nougat

The food product comprises a plant-based nougat component comprising from 0.5-20 wt % plant-based protein and from 1-30 wt % plant-based powder.

The plant-based nougat component may comprise from 0.5-20 wt % plant-based protein from 1-30 wt % plant-based powder. In some examples, the plant-based nougat is a low-sugar nougat, and comprises from 0.5-20 wt % plant-based protein, from 1-40 wt % soluble fiber and from 1-30 wt % plant-based powder, preferably from 15-25 wt % soluble fiber otherwise termed water-soluble dietary fiber and preferably from 1-20 wt % plant-based powder. Inclusion of a soluble fiber enables the amount of refined sugar to be reduced while maintaining product quality and organoleptic properties. Water-soluble dietary fibers are suitable for individuals suffering from diabetes as they do not result in an increase in blood glucose levels. The nougat may be termed a high fiber nougat, by virtue of the content of soluble fiber. Introducing these levels of fiber into the nougat result in a nutritious food product with a desirable sensory experience, and can reduce the amount of refined sugars and conventional humectants required to maintain user satisfaction and product lifetime.

The plant-based nougat component may comprise soluble dietary fiber in the form of a soluble corn fiber such as PROMITOR® 85L, a prebiotic soluble corn fiber in liquid form with at least 85% dietary fiber, and less than 2% sugars. The plant-based nougat component may comprise a soluble dietary fiber in the form of a naturally occurring polysaccharide such as a fructan, or an oligofructosaccharide. The plant-based nougat component may comprise a soluble dietary fiber derived from chicory root. Soluble dietary fibers, often called functional fibers, are prebiotic materials that have been proven to be important for advantageously balancing intestinal flora and supporting low-glycaemic diets. The soluble dietary fiber in the plant-based nougat component can impart a creamy texture and sweet taste, meaning less fat and less refined sugar needs to be included in the plant-based nougat.

The plant-based nougat component may comprise a plant-based powder, for example a powder derived from vegetables or fruits. As used herein, a “plant-based powder” is to be understood as being a distinct ingredient to any plant-based protein used to form the basis of the plant-based nougat. In some examples, the plant-based powder may be termed a plant-based colorant and/or a plant-based flavouring component, it being understood that the plant-based proteins used herein substantially lack any discernible odor or flavor and are primarily structural components of the nougat, conferring stability. The powder may be obtained by desiccating any suitable part of any suitable vegetables or fruits, and pulverising these desiccated vegetables or fruits by any appropriate means, to afford a powder. Equally, any of the above powders may be purchased. Desiccation of fruits or vegetables may be done by freeze-drying portions of the fruit or vegetable, or by heating at temperatures of no more than about 50° C., for example about 35° C. until a constant mass is obtained. Having a constant mass is an indication that the fruit or vegetable is fully desiccated, i.e. all water has been removed. Forming a powder from a desiccated material can be achieved through the use of any grinding apparatus: on a small scale, a pestle and mortar may be used, while grinding mills and industrial attritors may be used for large scale production.

A vegetable or fruit powder may be selected from the groups of root vegetables, winter squashes, and fruits. Examples of root vegetables that may be used to form plant-based powders include carrots, parsnips, swede, sweet potato (being a tuberous root vegetable), beets (including beetroot), cassava, ginger, turmeric. Ginseng, and lotus root. Examples of winter squashes include pumpkin, butternut squash, buttercup squash, acorn squash, spaghetti squash and ambercup squash. Examples of fruits include cherry, strawberry, raspberry, grape, mango, papaya, plum, peach, apricot, blueberry, blackberry and blackcurrant. Any part of the plant or vegetable that is fit for consumption may be used to produce the plant-based powder. For example, a whole beetroot, including the leafy tops may be used to form a beetroot-based powder, or the leafy tops may be omitted in other examples. In some examples, the vegetable or fruit powder is selected from any one of carrot, sweet potato, cherry, butternut squash or beetroot powder. In some examples, more than one type of fruit and/or vegetable may be used, in blended powder form. For example, a blend of two or more of strawberries, blackberries, raspberries, redcurrants and blackcurrants may be used to create a “fruits of the forest” flavoured powder.

In some examples, the plant-based powder may comprise or consist of powder obtained from drying upcycled vegetable or fruit. As used herein, the term “upcycled” refers to fruit or vegetable produce that is or has been discarded by a producer or retailer for being non-conforming with consumer expectation and that otherwise would not have gone to human consumption. These are procured and produced using verifiable supply chains, and upcycling such produce can have a positive impact on the environment. In addition to the plant-based powder being an upcycled powder of any of the vegetables or fruits described above, the plant-based powder may also comprise powder obtained by upcycling any other plant-based matter, including but not limited to coffee grounds, spent grain from the brewing and distilling industries, waste bread, cocoa by-products such as cocoa husk or any fruit based by product including pulp and peanut husks.

The plant-based nougat may be a brownie nougat. The plant-based nougat may comprise a chocolate component that renders it a plant-based brownie nougat. The plant-based nougat may comprise cocoa butter, cocoa liquor, cocoa powder or mixtures thereof, to form a plant-based brownie nougat.

Furthermore, the plant-based nougat comprises plant-based protein and sugar syrup. The plant-based nougat may also comprise a nut inclusion. It will be understood that the plant-based protein is in addition to any protein present in a nut inclusion. Advantageously, due to the combination of ingredients, the plant-based nougat is able to maintain a stable aerated sugar network without requiring egg or dairy protein as a stabiliser. Stability refers to the ability of the nougat to maintain its structure without collapsing, separating or splitting.

The plant-based nougat may comprise 30-75 wt %, or 40-65 wt %, or 45-55 wt % sugar syrup). The sugar syrup may be selected from sucrose, glucose, invert syrup, honey, and mixtures thereof. The sugar syrup may comprise water. For example, the sugar syrup may comprise 1-20 wt % water and 99-85 wt % sugars, preferably 10-20 wt % water and 90-80 wt % sugars. The nougat may comprise or be formed from at least 50 wt % sugar syrup, optionally at least 60 wt % sugar syrup, optionally at least 65 wt % sugar syrup, optionally at least 70 wt % sugar syrup. The plant-based nougat may comprise 41-72 wt % sugar, preferably 56-76 wt % sugar, most preferably 60-68 wt % sugar (sugar in this context being the dry sugar). The sugar may be selected from sucrose, glucose, sugar from invert syrup, sugar from honey, and mixtures thereof.

In some examples, the plant-based nougat comprises less than 30 wt %, for example less than 20 wt %, for example less than 15 wt %, for example less than 10 wt % of an added or simple sugar, for example a refined sugar selected from pure sucrose, fructose or glucose, or a syrup thereof.

The plant-based nougat may comprise 0.5-20 wt %, preferably 1-15 wt %, most preferably 2-10 wt % plant-based protein. It will be understood that these amounts do not include plant-based protein present in other ingredients of the nougat, e.g., the nut inclusion. The plant-based protein of the plant-based nougat may be selected from potato proteins, for example potato protein isolate, legume water and soybean proteins, for example soy protein isolate, although the skilled person will appreciate that other sources of plant-based protein are also suitable. The plant-based protein and the sugar syrup are able to form a stable aerated sugar network.

This invention may make use of either a native potato protein mixture, which can be added in form of a general potato protein isolate or it makes use of a patatin isolate or protease inhibitor isolate. The present inventors have found that potato proteins are particularly effective in the production process in that the aerated products are particularly stable compared to equivalent products produced with other plant proteins, and can produce nougat that is comparable in taste, texture and appearance to nougat produced with animal proteins, such as egg or milk proteins.

Potato proteins can be classified in a number of ways. In one classification, the potato protein can be classified depending on whether it is acid soluble or acid coagulable. Acid soluble proteins are those that solubilise in water at a pH of 3 to 5, while acid coagulable proteins are those that are insoluble in water at a pH of from 3 to 5 (since they have coagulated). The acid soluble potato proteins can be fractionated, i.e., isolated from or separated from, the acid coagulable potato proteins. Acid soluble proteins tend to have a higher molecular weight than the acid soluble proteins. The acid soluble proteins have been found to have a molecular weight in the range of 32 to 87 kDa, as measured by SDS-PAGE analysis. The acid coagulable potato proteins have been found to have a molecular weight of from 17 to 28 kDa, as measured by SDS-PAGE analysis. The potato protein isolate may comprise a potato protein that has been isolated and fractionated on the basis of molecular weight, e.g., potato protein isolate that has been fractionated into an isolate containing predominantly proteins that are acid soluble or those that are acid coagulable.

In an embodiment, at least 50 wt %, optionally at least 75 wt %, optionally at least 90 wt %, optionally at least 95 wt %, of the potato protein isolate contain potato proteins having a molecular weight of 30 kDa or more, as measured by SDS-PAGE analysis. Potato protein having such a molecular weight are commercially available, e.g., Solanic 200, available from Avebe. Such potato protein comprises patatin, which is a family of glycoproteins.

Nougat produced with this type of potato protein was found to have a slightly darker colour compared to that of lower molecular weight protein, and a slightly more of a potato taste. Its texture comparable with that of the nougat made in the traditional way with egg or milk protein.

In an embodiment, at least 50 wt %, optionally at least 75 wt %, optionally at least 90 wt %, optionally at least 95 wt %, of the potato protein isolate contain potato proteins having a molecular weight of less than 30 kDa, as measured by SDS-PAGE analysis. Potato proteins having such a molecular weight are commercially available, e.g., Solanic 3000, available from Avebe. Such potato protein comprises protease inhibitors. Methods of obtaining such a potato protein have been published, e.g., in WO 2008/069650. Nougat produced with this type of potato protein was found to have the same colour and substantially the same texture and taste as nougat made in the traditional way with egg or milk protein. It seemed to require less whipping time than nougat made with higher molecular weight potato protein.

Fractions or derivatives of the above can be used. These proteins or fractions thereof, mentioned above, are preferably dosed in a form of dry potato protein powder with a moisture content 5-10 wt %. The quantity of native potato protein present in the nougat may be from 0.5-15 wt % of the nougat, optionally 0.5-10 wt %, optionally 0.5-8.0 wt % of the nougat.

Legume water is water in which legume seeds such as chickpeas have been cooked and/or soaked. The legume seeds may be haricot beans, chickpeas, whole green lentils, split yellow peas, soybeans and the like. Preferably, the legume seeds are chickpeas. Legume water formed from chickpeas is known as “aquafaba”. In one aspect, the plant-based protein is aquafaba.

The legume water may comprise further ingredients, or may consist of legume water. Preferably the legume water may comprise salt. The salt may be present in an amount of 1-10 wt %, preferably 3-7 wt %, most preferably about 5 wt % of the legume water. An exemplary legume water comprises 99-90 wt % chickpea water and 10-1 wt % salt; preferably 97-93 wt % chickpea water and 7-3 wt % salt, most preferably about 95 wt % chickpea water and about 5 wt % salt.

The plant-based protein may be provided in the form of a dry powder, for example a potato protein powder, or a soybean protein powder. Advantageously, dry powder forms of protein are efficient for use in large-scale industrial manufacturing processes.

The plant-based nougat may comprise a nut inclusion, for example, 5-50 wt % nuts, preferably 10-40 wt % nuts, most preferably 20-30 wt % nuts. When present, the nuts in the plant-based nougat may be one or more of whole nuts and chopped nuts, for example chopped nuts of about 2-4 mm in size. The whole nuts or the chopped nuts in the plant-based nougat may be selected from peanuts, almonds, cashew nuts, brazil nuts, hazelnuts, pistachio nuts, pecan nuts, walnuts and macadamia nuts. Most preferably, the nuts are peanuts.

The density of the plant-based nougat may be 600-1100 kg/m3, preferably 800-1000 kg/m³, most preferably about 890 kg/m³.

A nougat typically lacks gelatin and/or a gelling starch, e.g., the plant-based nougat may contain less than 5 wt % gelatin and/or a gelling starch, optionally less than 2 wt % gelatin and/or a gelling starch, optionally less than 1 wt % gelatin and/or a gelling starch, optionally less than 0.5 wt % gelatin and/or gelling starch, optionally no gelatin and/or gelling starch.

Advantageously, the plant-based nougat provides sensory properties that are acceptable in comparison to typical non-plant based nougats.

### Process for Making Plant-Based Nougat

Herein is provided a method of producing a plant-based nougat, the method comprising aerating a whip solution comprising plant-based protein, wherein a sugar syrup is added to the whip solution before, during or after aerating the whip solution, to form a frappe, and adding a plant-based powder to the frappe to form the plant-based nougat. In alternative embodiments, the plant-based powder is added to the whip solution before aeration to form the frappe, and the frappe then is a nougat. The plant-based powder may be added to the frappe as part of a slurry. The slurry may comprise the plant-based powder dispersed in a matrix of fat, for example palm oil.

The plant-based nougat may be made by a process comprising the steps of:
providing a whip solution comprising plant-based protein;
aerating the whip solution;
adding a heated sugar syrup to the whip solution;
whipping the whip solution comprising the added sugar syrup to form a frappe; and
folding a plant-based powder into the frappe.

In some embodiments the plant-based powder is first added to a fat based medium or matrix and then added to the frappe

The sugar syrup may be added to the whip solution before the whip solution is aerated. Preferably, the sugar syrup is added to the whip solution after the whip solution is aerated.

That is, preferably the process for making plant-based nougat comprises the steps of:
providing a whip solution comprising plant-based protein;
aerating the whip solution to provide an aerated whip solution;
adding heated sugar syrup to the aerated whip solution;
whipping the aerated whip solution comprising the added sugar syrup to form a frappe; and
folding a plant-based powder into the frappe.

In examples in which the plant-based nougat is a low-sugar plant-based nougat, the sugar syrup used in the above mentioned processes may include or be substantially replaced by a syrup of soluble fiber as described herein.

The term “frappe” refers to an aerated or foamed mixture comprising sugars and proteins which is stabilised by the proteins.

The process may further comprise folding one or more nut inclusions into the frappe, for example by folding nut inclusions at the same time as a nut butter is folded into the frappe. The nut inclusions may form 5-50 wt %, preferably 10-40 wt %, most preferably 20-30 wt % of the ingredients used to make the plant-based nougat. The nut inclusions are as described above in connection with the plant-based nougat and may be whole or chopped nuts, or a nut butter.

The plant-based protein, plant-based powder, sugar syrup, and nut inclusion are as described above in connection with the plant-based nougat. For example, the nut inclusion may be whole or chopped nuts. Providing the whip solution may comprise adding plant-based protein in dry powder form to water. Alternatively, providing the whip solution may comprise adding plant-based protein in the form of a solution or suspension of the plant-based protein in a liquid, such as water, to water or a further amount of water, which may be in a sugar syrup. Alternatively, the whip solution may be in the form of legume water, as described above in connection with the plant-based nougat.

The whip solution may form 0.5-45 wt %, preferably 1-15 wt %, most preferably 2-10 wt % of the ingredients used to make the plant-based nougat. The sugar syrup may form 30-75 wt %, or 40-65 wt %, or 45-55 wt % of the ingredients used to make the plant-based nougat. The nut inclusion may form 5-50 wt %, preferably 10-40 wt %, most preferably 20-30 wt % of the ingredients used to make the plant-based nougat.

The sugar syrup may be heated to 110-150° C., preferably 115-145° C., most preferably 120-140° C.

Suitable aeration techniques include dispersing air into the mixture under pressure or utilising a pressure beater to aerate the mixture. Aeration may also be achieved by whisking. Aeration may be effected in a pressurised system using a pressure beater. Such devices generally comprise a stator and rotor, which may be provided with pins, forming a ‘pin beater’. In this arrangement, the mixture is mixed in a container into which pressurised air is fed. The pressure of air applied will depend upon factors such as the consistency of the medium (comprising sugars and protein) to be aerated, and the parameters of the pressurised system, for example, the degree of back pressure delivered into the pressure device by a downstream pressure valve, but will typically be in the range of 3-5 bar. Suitable mixing speeds will be in the range of 300-1200 rpm. The temperature at which the aeration is carried out is selected so as to ensure that the viscosity of the mixture is suitable to allow it to be beaten and for air bubbles to be entrapped and dispersed within it and hold the air bubbles within it. It may be in the range of from 25-110° C., or 30-90° C., or 35-65° C., although at the higher levels, proteins may coagulate. If this is not required, then the temperatures may be kept below 65° C. Whipping refers to high intensity stirring. Whipping may also cause aeration.

### Plant-Based Caramel

The food product comprises a plant-based caramel component. The plant-based caramel may comprise a plant-based milk, plant-based protein, plant-based fat, and sugar syrup. In some examples, the plant-based caramel comprises from 1-70 wt %, preferably 1-50 wt % sugar syrup, for example glucose syrup.

In some examples, the plant-based caramel component is a low-sugar plant-based caramel component wherein some or all of the sugar syrup is replaced with from 1-70 wt %, preferably 1-50 wt % soluble fiber otherwise termed water-soluble dietary fiber. Inclusion of a soluble fiber enables the amount of refined sugar to be reduced while maintaining product quality and organoleptic properties. Water-soluble dietary fibers are suitable for individuals suffering from diabetes as they do not result in an increase in blood glucose levels. The caramel may be termed a high fiber caramel, by virtue of the content of soluble fiber. Introducing these levels of fiber into the caramel result in a nutritious food product with a desirable sensory experience, and can reduce the amount of refined sugars and conventional humectants required to maintain user satisfaction and product lifetime.

The plant-based caramel component may comprise soluble dietary fiber in the form of a soluble corn fiber such as PROMITOR® 85L, a prebiotic soluble corn fiber in liquid form with at least 85% dietary fiber, and less than 2% sugars. The plant-based caramel component may comprise a soluble dietary fiber in the form of a naturally occurring polysaccharide such as an inulin, a fructan, or an oligofructosaccharide. The caramel component may comprise a soluble dietary fiber derived from chicory root. Soluble dietary fibers, often called functional fibers, are prebiotic materials that have been proven to be important for advantageously balancing intestinal flora and supporting low-glycaemic diets. The soluble dietary fiber in the plant-based caramel component can impart a creamy texture and sweet taste, meaning less fat and less refined sugar needs to be included in the caramel.

In some examples, the plant-based caramel comprises soluble dietary fiber and a sugar syrup such as an invert syrup. In some examples, the plant-based caramel comprises soluble dietary fiber, a sugar syrup such as an invert syrup and added glucose.

The sugar syrup may be selected from sucrose, glucose, invert syrup, honey, and mixtures thereof. The sugar syrup may comprise water. The plant-based caramel may comprise less than 50 wt %, for example less than 40 wt %, for example less than 30 wt %, for example less than 20 wt %, for example less than 10 wt %, for example from 1 to 10 wt % sugar syrup. The inclusion of soluble dietary fiber enables the use of lower amounts of refined sugars and sugar syrups. In some examples, the sugar syrup is invert sugar syrup. The plant-based caramel component may comprise less than 50 wt %, for example less than 40 wt %, for example less than 30 wt %, for example less than 20 wt %, for example less than 10 wt %, for example from 1 to 10 wt % sugar invert syrup.

In some examples, the plant-based caramel comprises less than 30 wt %, for example less than 25 wt %, for example less than 20 wt %, for example less than 10 wt % of an added or simple sugar, for example a refined sugar selected from pure sucrose, fructose or glucose, or a syrup thereof.

In some examples, the plant-based caramel comprises from 1 to 70 wt % (for example from 1 to 50 wt %) soluble dietary fiber and from 1 to 50 wt % (for example from 1 to 20 wt %, for example from 1 to 10 wt %) of a sugar syrup such as an invert syrup. In some examples, the plant-based caramel comprises from 1 to 70 wt % (for example from 1 to 50 wt %) soluble dietary fiber, from 1 to 50 wt % (for example from 1 to 20 wt %, for example from 1 to 10 wt %) of a sugar syrup such as an invert syrup and less than 10 wt % added glucose.

The plant-based caramel may comprise a plant-based milk selected from coconut milk, almond milk, soy milk, rice milk, cashew milk, hemp milk, oat milk, flax milk, hazelnut milk, pea milk, and mixtures thereof. Preferably the plant-based milk is selected from coconut milk and/or soy milk. The plant-based milk may be present in the plant-based caramel in an amount of from 15-55 wt %, for example 25-45 wt %, for example from 30-40 wt %. The plant-based milk may be commercially available.

The plant-based caramel may be formed from a plant-based flour and/or plant-based protein powder, for example, nut flours and/or nut protein powders. The plant-based caramel may be formed by combining a nut flour, or nut protein, with water and sugar to afford a “milkmix”. The nut flour, or nut protein, may be present in the milkmix in an amount from 1 to 40 wt %, for example 1 to 30 wt %, for example from 1 to 20 wt %. The nut flour or nut protein powder may be derived from peanuts, almonds, cashew nuts, brazil nuts, hazelnuts, pistachio nuts, pecan nuts, walnuts and macadamia nuts and combinations thereof. The sugar may be a refined sugar selected from pure sucrose, fructose or glucose, or a syrup thereof present in an amount from 1 to 70 wt %, for example 1 to 60 wt %, for example 15 to 50 wt %, for example from 20 to 40 wt %. Water may be present in an amount to account for the remaining balance.

The plant-based fat may be selected from peanut oil, palm oil, cocoa butter, palm fat, olive oil, and sunflower oil, and mixtures thereof. It will be understood that the plant-based fat is in addition to fat present in the plant-based milk. The fat may be present in the caramel in an amount of from 1 to 30 wt %, for example from 1 to 20 wt %, for example 1 to 15 wt %.

The plant-based caramel may comprise a humectant. The humectant may be a polyol. The humectant may be selected from sorbitol, glycerol, hydrogenated starch hydrolysates, hydrogenated isomaltose, maltitol, mannitol, xylitol, erythritol, and mixtures thereof. The humectant is preferably glycerol. The plant-based caramel may comprise 0.5-60 wt %, 2-30 wt %, preferably 5-25 wt %, most preferably 10-20 wt % of the humectant.

The density of the plant-based caramel may be 800-1400 kg/m³, for example about 1160 kg/m³, most preferably 400-1400 kg/m³.

The plant-based caramel may further comprise inclusions. The plant-based caramel preferably further comprises nuts. The plant-based caramel may comprise 5-50 wt % nuts, preferably 5-30 wt % nuts, most preferably 10-20 wt % nuts. When present, the nuts in the plant-based caramel may be one or more of whole nuts and chopped nuts. The whole nuts or the chopped nuts in the plant-based caramel may be selected from peanuts, almonds, cashew nuts, brazil nuts, hazelnuts, pistachio nuts, pecan nuts, walnuts and macadamia nuts. Most preferably, the nuts are peanuts.

Advantageously, the plant-based caramel provides sensory properties that are equivalent to caramels with much higher refined sugar content as well as typical non-plant-based caramels.

### Process for Making Plant-Based Caramel

The caramel may be made by a process comprising the steps of:
providing a batch milk comprising a “milkmix” comprising a plant-based milk and plant-based fat, or a plant-based flour and a plant-based fat; and
adding a heated sugar syrup to the batch milk to form a caramel.

The method may include adding a soluble fiber to the batch milk, at the same time as, or at a different time to, the addition of the sugar syrup, or in place of some or all of the sugar syrup. The process may further include mixing inclusions into the caramel.

The sugar syrup may be heated to 115-145° C., preferably 120-140° C., most preferably 125-135° C. The sugar syrup may form 25-55 wt %, preferably 30-50 wt %, most preferably 35-45 wt % of the ingredients used to make the plant-based caramel. The soluble fiber may be added to the sugar syrup before heating, or may be heated separately to the same temperature and added to the batch milk separately.

The batch milk may be heated before the sugar syrup is added, preferably to 30-80° C., most preferably to 40-70° C. The process may include a further step of heating the caramel to evaporate moisture and form a browned caramel, preferably at a temperature of 100-150° C., most preferably 120-145° C. Advantageously, the browned caramel has an improved flavour. The heating time and temperature can be adjusted depending on need, with longer times and higher temperatures leading to a darker browned caramel with a more intense flavour. The soluble fiber included in the caramel does not adversely affect the formation or qualities of the caramel and can in fact improve consumer experience while reducing sugar and calorie content.

The process may include a further step of adding a humectant to the caramel. Preferably, the humectant is added to the browned caramel. The humectant may form 1-20 wt %, or 3-15 wt %, or 7-12 wt % of the ingredients used to make the plant-based caramel. Advantageously, the humectant improves the rheological properties of the plant-based caramel, making it more suitable for use in downstream processes. The humectant is as described above.

The batch milk may comprise further ingredients selected from sugars such as glucose, flavourings such as vanilla extract, salt, and mixtures thereof. For example, the batch milk may comprise sugars such as glucose forming 1-25 wt %, or 5-15 wt % of the ingredients used to make the plant-based caramel.

The plant-based milk or plant-based flour may form 15-55 wt %, preferably 25-45 wt %, most preferably 30-40 wt % of the ingredients used to make the plant-based caramel. The plant-based fat may form 1-20 wt %, preferably 3-15 wt %, most preferably 5-10 wt % of the ingredients used to make the plant-based caramel. It will be understood that these amounts do not include plant-based fat present in the other ingredients of the caramel, e.g., the plant-based milk.

The plant-based caramel may have a moisture content ranging from 0.1 wt % to 16 wt %, preferably from 0.5 wt % to 14 wt %, even more preferably from 5.0 wt % to 14 wt

The plant-based caramel of the present invention may have a density of 100-8000 kg/m³, preferably 500-5000 kg/m³, more preferably 600-3000 kg/m³, more preferably 800-1500 kg/m³, most preferably 400-1400 kg/m³.

The process for making plant-based caramel may include mixing the ingredients in a heating vessel; heating the ingredients to form a uniform heated mixture while scraping the vessel during heating to prevent scorching; and increasing the heat to boil the ingredients to a temperature and for a time to achieve a desired level of caramelisation. The process may include mixing the nut inclusion into the caramel prior to heating to achieve caramelisation, or it may include mixing the nut inclusion into the caramel after caramelisation has been achieved.

### Plant-Based Chocolate

The food product comprises a plant-based chocolate component. The plant-based chocolate component may be a low-sugar plant-based chocolate component comprising from 1-30 wt % soluble fiber. In some examples, the chocolate component comprises a low-sugar plant-based milk chocolate comprising one or more dietary fibers selected from dextrin, inulin and a fructooligosaccharide. Soluble dietary fibers such as these have been found suitable for replacing refined sugars without any loss of sweetness, while simultaneously enhancing the creaminess of a food product.

The plant-based chocolate component may comprise one or more types of soluble dietary fiber as a major component of the plant-based chocolate component. The one or more types of soluble dietary fiber may be present in a greater amount than any added or refined sugar component. For example, the plant-based chocolate component may comprise from 1-30 wt % of a soluble dietary fiber, for example from 10-30 wt %, for example from 20-30 wt %. It will be understood that the plant-based chocolate component may also include other ingredients required to make a plant-based milk chocolate, including cocoa butter, cocoa liquor, plant-based milk, plant-based fats such as vegetable fats, and a flavouring such as vanilla.

In some examples, the plant-based milk chocolate comprises less than 30 wt %, for example less than 25 wt %, for example less than 20 wt % of an added or simple sugar, for example a refined sugar selected from pure sucrose, fructose or glucose, or a syrup thereof.

Plant-based chocolates are readily available from a number of commercial suppliers. The plant-based chocolate may be a compound chocolate. The plant-based chocolate is preferably a plant-based “milk chocolate”. Plant-based “milk chocolates” may comprise sugar, cocoa butter, cocoa solids, and a plant-based milk. It has been found that a plant-based “milk chocolate” or couverture chocolate comprising rice milk provides a good flavour profile in combination with the other components of the food product.

### Process for Making Food Product

Herein is provided a method of producing a food product, the method comprising combining the plant-based nougat component, the plant-based caramel component and the plant-based chocolate component to form the food product.

In an embodiment, the plant-based nougat component is produced and then the other components of the food product are coated onto the plant-based nougat component.

In an embodiment, the plant-based nougat is produced, preferably in the form of a layer, and then the plant-based caramel is coated on one or more sides of the plant-based nougat, and then the plant-based chocolate is coated onto the plant-based nougat and plant-based caramel on at least one side, optionally all sides of the plant-based nougat and plant-based caramel to completely envelope the plant-based nougat and plant-based caramel in the plant-based chocolate.

In order to ease processing, the plant-based nougat may be in chilled form during production, as this will reduce viscosity of the plant-based nougat and enable the chocolate component in liquid form to more quickly solidify during enrobing.

### EXAMPLES

### Example 1—Beetroot Brownie Nougat

A plant-based nougat was prepared from the following ingredients:
1. Frappe (50 wt %) comprising:
   a) Whip Solution (13 wt %):
      80 wt % Base Syrup
      14 wt % Water
      6 wt % potato protein (Solanic® 200)
   Total 100%
   b) Sugar Syrup (87 wt %):
      38wt % Glucose 62DE
      34 wt % Granulated sugar
      7 wt % Invert sugar
      20 wt % Water
      1 wt % Salt
   Total 100%
      Total 100%
2. Beetroot slurry (26 wt %) comprising:
   9 wt % Choc Liquor
   30 wt % soft palm fat
   51 wt % Beetroot powder
   10 wt % plant-based chocolate
   Total 100%
3. Chopped peanuts (24 wt %)

The whip solution was aerated, the sugar syrup was cooked to 140° C. and added to the aerated whip solution and the result was whipped into a frappe. The chopped peanuts and the beetroot (brownie) slurry were added to the frappe.

A plant-based caramel was prepared from the following ingredients:
1. Caramel Syrup (55 wt %) comprising:
   >98 wt % Syrup 69 DE
   1 wt % Salt
   <1 wt % Vanilla Flavouring
   Total 100%
2. Batch milk (45 wt %) comprising:
   a) Milk mix (83 wt %):
      33 wt % Water
      13 wt % Soy protein powder
      54 wt % Granulated sugar
      Total 100%)
   b) Fat (17wt %):
      100 wt % soft palm fat
      Total 100%

The batch milk was warmed to 60 to 70° C. The syrup was cooked to 130 to 140° C. and added to the batch milk. The resulting caramel was cooked at 130 to 140° C. Peanuts may be subsequently mixed into the caramel.

A food product was made from the plant-based nougat, the plant-based caramel, and a commercially available plant-based milk chocolate. The product contained 51 wt % of the nougat (which contained 24 wt % peanuts), 14wt % of the caramel, and 35 wt % of the chocolate.

### Example 2—Carrot Nougat

A similar nougat slurry (26 wt % of the nougat component) was prepared and incorporated into another otherwise identical nougat component and food product as for Example 1. The nougat slurry comprised 30 wt % palm fat, 51 wt % carrot powder and 19 wt % “milk compound”.

### Example 3—Butternut Squash Nougat

A plant-based nougat was prepared from the following ingredients:
1. Frappe (56 wt %) comprising:
   a) Whipping mix (86 wt %):
      93 wt % Raw Syrup comprising:
         40 wt % Syrup 63 DE
         40 wt % Sugar
         >19 wt % Water
         <1 wt % wt% Salt
         Total 100%
      7 wt % potato protein (Solanic® 200)
      Total 100%
   b) Water (14 wt %)
   Total 100%
2. Slurry (14 wt %) comprising:
   Palm Oil (75 wt %)
   Butternut Squash Powder (21 wt %)
   Vanilla Flavour (4 wt %)
   Total 100%
3. Peanut Splits (30 wt %)

The whip solution was aerated, the sugar syrup was cooked to 50 to 60° C. and added to the aerated whip solution and the result was whipped into a frappe. The chopped peanuts and the slurry were added to the frappe.

A plant-based caramel was prepared from the following ingredients:
1. Sugar Syrup (71 wt %) comprising:
   67 wt % Syrup 63 DE
   1 wt % Salt
   24 wt % sugar
   <1 wt % Vanillin
   8 wt % Water
   Total 100%
2. “Milk” mix (29 wt %) comprising:
   a) Recon (50 wt %):
      30 wt % Peanut flour
      35 wt % Water
      35 wt % Sugar
      Total 100%
   b) Fat (50 wt %):
      100 wt % Palm Oil (4R400)
   Total 100%

The Recon was mixed for 20 min (1700 rpm). The Recon and fat were then mixed for 20 min (2800 rpm) to form the “Milk” mix. The “Milk” mix was warmed to 60 to 70° C. The syrup was cooked to 100 to 120° C. and added to the batch milk. The resulting caramel was cooked at 100 to 120° C.

### Example 4—Cherry Nougat

A similar slurry (14 wt % of the nougat component) was prepared and incorporated into another otherwise identical nougat component as described for Example 3. The slurry comprised Palm Oil (81 wt %), Acerola Cherry Powder (9 wt %), Beetroot Powder (9 wt %) and Natural Cocoa Powder (<1 wt %).

Two food products were made from the two plant-based nougats (butternut and cherry), the plant-based caramel, and a commercially available plant-based milk chocolate. Photographs of the butternut squash nougat bar, and the cherry nougat bar are shown in FIGS. 1 and 2 respectively.

### Example 5—Beetroot Nougat

A plant-based nougat was prepared from the following ingredients:
1. Frappe (52 wt %) comprising:
   a) Whipping mix (86 wt %):
      93 wt % Raw Syrup comprising:
         40 wt % Syrup 63 DE
         40 wt % Sugar
         >19 wt % Water
         <1 wt % Salt
         Total 100%
      7 wt % potato protein (Solanic® 200)
      Total 100%
   b) Water (14 wt %)
   Total 100%
2. Slurry (25 wt %) comprising:
   Palm Oil (53 wt %)
   Beetroot Powder (47 wt %)
   Total 100%
3. Peanut Splits (23 wt %)

The whip solution was aerated, the sugar syrup was cooked to 130 to 140° C. and added to the aerated whip solution and the result was whipped into a frappe. The chopped peanuts and the slurry were added to the frappe.

A plant-based caramel was prepared from the following ingredients:
1. Sugar Syrup (71 wt %) comprising:
   67 wt % Syrup 63 DE
   1 wt % Salt
   24 wt % sugar
   8 wt % Water
   Vanillin
   Total: 100%
2. “Milk” mix (29 wt %) comprising:
   a) Recon (50 wt %):
      20 wt % Almond protein powder
      20.00 wt % Water
      60 wt % Sugar
      Total 100%
   b) Fat (50 wt %):
      100 wt % Palm Oil (4R400)
   Total 100%

The Recon was mixed for 30 min (1500 rpm). The Recon and fat were then mixed for 20 min (2600 rpm) to form the “Milk” mix. The “Milk” mix was warmed to 60 to 70° C. The syrup was cooked to 120 to 130° C. and added to the batch milk. The resulting caramel was cooked at 120 to 130° C.

### Example 6—Purple Sweet Potato Nougat

A similar slurry (25 wt % of the nougat component) was prepared and incorporated into another otherwise identical nougat component as described in Example 5. The slurry comprised Palm Oil (78 wt %), Purple Sweet Potato Powder (22 wt %).

Two food products were made from the two plant-based nougats (beetroot and purple sweet potato), the plant-based caramel, and a commercially available plant-based milk chocolate. Photographs of the beetroot nougat bar, and the purple sweet potato nougat bar are shown in FIGS. 3 and 4 respectively.

The product was in the form of a bar having a layer of the nougat and a layer of the caramel, encased in the chocolate. A taste panel found the product to be an enjoyable confectionery product, notwithstanding that it was a plant-based low-calorie food product.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications can be covered by the appended claims.

1. A food product comprising:
a plant-based nougat component, wherein the plant-based nougat component comprises from 0.5-20 wt % plant-based protein and from 5-20 wt % plant-based powder;
a plant-based caramel component;
a plant-based chocolate component.

2. The food product according to claim 1, wherein the plant-based nougat component comprises 30-75 wt % sugar syrup.

3. The food product according to claim 1, wherein the plant-based nougat component comprises 1-15 wt % plant protein isolate.

4. The food product according to claim 1, wherein the plant-based nougat comprises from 1-40 wt % soluble fiber.

5. The food product according to claim 1, wherein the plant-based caramel component comprises from 1-70 wt % soluble fiber.

6. The food product according to claim 1, wherein the plant-based chocolate component comprises from 1-30 wt % soluble fiber.

7. The food product according to claim 1, wherein the plant-based powder is a vegetable powder or fruit powder, optionally wherein the vegetable powder or fruit powder is selected from carrot powder, sweet potato powder, cherry powder, butternut squash powder and beetroot powder.

8. The food product according to claim 1, wherein the plant-based nougat component comprises from 15-25 wt % soluble fiber, and/or wherein the soluble fiber comprises soluble fiber in the form of a soluble corn fiber or an oligofructosaccharide.

9. The food product according to claim 1, wherein the plant-based nougat component comprises less than 10 wt % of an added sugar selected from sucrose or glucose.

10. The food product according to claim 1, wherein the plant-based nougat component comprises a nut inclusion of one or more of whole nuts and chopped nuts, wherein the whole nuts and chopped nuts are selected from peanuts, almonds, cashew nuts, brazil nuts, hazelnuts, pistachio nuts, pecan nuts, walnuts and macadamia nuts.

11. The food product according to claim 1, wherein the plant-based caramel component comprises a plant-based milk, plant-based protein, plant-based fat, sugar syrup, and an inclusion.

12. The food product according to claim 11, wherein the inclusion in the caramel component comprises one or more of whole nuts and chopped nuts.

13. The food product according to claim 1, wherein the plant-based caramel component comprises less than 30 wt % of an added sugar selected from sucrose or glucose or a syrup thereof.

14. The food product according to claim 1, wherein the plant-based caramel component comprises from 1 to 50 wt % soluble fiber, and/or wherein the plant-based caramel component comprises soluble fiber in the form of a soluble corn fiber, an inulin or a fructooligosaccharide.

15. The food product according to claim 1, wherein the plant-based caramel component comprises from 1 to 50 wt % invert sugar syrup.

16. A method of producing the plant-based nougat component according to claim 1, the method comprising aerating a whip solution comprising a plant-based protein, wherein a sugar syrup is added to the whip solution before, during or after aerating the whip solution, to form a frappe, adding a plant-based powder to the frappe to form the plant-based nougat, and optionally adding inclusions to the plant-based nougat component, wherein the inclusions comprise nuts.

17. The food product according to claim 1, which is in the form of a bar comprising a layer of the plant-based caramel component and a layer of the plant-based nougat component, wherein the plant-based caramel layer and the plant-based nougat layer are enrobed in the plant-based chocolate component.

18. (canceled)

19. The food product according to claim 1, wherein the plant-based chocolate component comprises a low sugar plant-based milk chocolate, having less than 30 wt % added sugar selected from sucrose, glucose and fructose.

20. The food product according to claim 1, wherein the plant-based chocolate component comprises a low sugar plant-based milk chocolate comprising one or more soluble fiber selected from dextrin, inulin and fructooligosaccharide.

21. The food product according to claim 1, comprising:
1-70 wt % of the plant-based nougat component;
1-60 wt % of the plant-based caramel component;
and
1-60 wt % of the plant-based chocolate component.

22. (canceled)
